(19) United States
(12) Patent Application Publication
(10) Pub. No.: US 2015/0092314 A1
(43) Pub. Date: Apr. 2, 2015

(54) CONNECTOR PLACEMENT FOR A SUBSTRATE INTEGRATED WITH A TOROIDAL INDUCTOR

(71) Applicant: QUALCOMM Incorporated, San Diego, CA (US)

(72) Inventors: Daeik Daniel Kim, San Diego, CA (US); Young Kyu Song, San Diego, CA (US); Mario Francisco Velez, San Diego, CA (US); Jonghae Kim, San Diego, CA (US); Changhan Hobie Yun, San Diego, CA (US); Chengjie Zuo, Santee, CA (US); Xiaonan Zhang, San Diego, CA (US); Ryan David Lane, San Diego, CA (US); Matthew Michael Nowak, San Diego, CA (US)

(73) Assignee: QUALCOMM Incorporated, San Diego, CA (US)

(21) Appl. No.: 14/039,192

(22) Filed: Sep. 27, 2013

(51) Int. Cl. H01F 27/29; H01F 41/04; H01F 27/40

(52) U.S. Cl. CPC H01F 27/29; H01F 27/40; H01F 41/04
USPC 361/270; 336/192; 29/602.1

(57) ABSTRACT

A system includes a first connector coupled to a first surface of a substrate. The first connector enables the system to be electrically coupled to a first device external to the substrate. The system includes a second connector coupled to a second surface of the substrate. The system also includes a plurality of conductive vias extending through the substrate from the first surface to the second surface. The plurality of conductive vias surrounds the first connector and the second connector. The plurality of conductive vias is electrically coupled together to form a toroidal inductor. A first lead of the toroidal inductor is electrically coupled to the first connector. A second lead of the toroidal inductor is electrically coupled to the second connector.

### I. FIELD

The present disclosure is generally related to connector placement for a substrate integrated with a toroidal inductor.

### II. DESCRIPTION OF RELATED ART

Advances in technology have resulted in smaller and more powerful computing devices. For example, there currently exists a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Inductors are used in power regulation, frequency control, and signal conditioning applications in many electronic devices. For example, a radio frequency (RF) chipset may use toroidal inductors. Toroidal inductors can have certain functional benefits relative to other inductor configurations. For example, a magnetic field of a toroidal inductor is contained within coils of the inductor, which may reduce electromagnetic interference relative to other inductor configurations. However, because toroidal inductors are not space efficient, designing circuits with toroidal inductors may be difficult due to space constraints.

### III. SUMMARY

This disclosure presents particular embodiments that simplify use of toroidal inductors in circuits by efficiently utilizing space associated with the toroidal inductors. For example, using through via manufacturing technologies (e.g., through-glass-via or through-silicon-via technologies), a substrate may be integrated with a toroidal inductor. The toroidal inductor may include conductive vias that are electrically coupled together to form the toroidal inductor. Connectors for the toroidal inductor that enable the toroidal inductor to be coupled to devices external to the substrate may be positioned on surfaces of the substrate and may be surrounded by conductive vias of the toroidal inductor. Surrounding the connectors for the toroidal inductor with the conductive vias of the toroidal inductor may locate the connectors close to the toroidal inductor to limit additional resistance associated with leads that couple the toroidal inductor to the connectors. The additional resistance may degrade overall circuit performance in terms of additional power consumption. Surrounding the connectors of the toroidal inductor with the conductive vias of the toroidal inductor may utilize space associated with a central region of the toroidal inductor and result in a device with a smaller footprint than a device that has connectors external to the central region of the toroidal inductor.

In a particular embodiment, a device includes a substrate. The device includes a first connector coupled to a first surface of the substrate. The first connector is configured to be electrically coupled to a first device external to the substrate. The device includes a second connector coupled to a second surface of the substrate. The device includes a plurality of conductive vias extending through the substrate from the first surface to the second surface and surrounding the first connector and the second connector. The plurality of conductive vias are electrically coupled together to form a toroidal inductor. A first lead of the toroidal inductor is electrically coupled to the first connector. Also, a second lead of the toroidal inductor is electrically coupled to the second connector.

In a particular embodiment, a method includes forming a first connector on a first surface of a substrate. The first connector is configured to be electrically coupled to a first device external to the substrate. The first connector is surrounded by a plurality of conductive vias that are electrically coupled together to form a toroidal inductor integral with the substrate. The method includes electrically coupling the first connector to the toroidal inductor. The method includes forming a second connector on a second surface of the substrate. The second conductor is configured to be electrically coupled to a second device external to the substrate. The second connector is surrounded by the plurality of conductive vias. The method also includes electrically coupling the second connector to the toroidal inductor.

In a particular embodiment, a computer-readable storage device stores instructions that, when executed by a processor, cause the processor to initiate formation of a first connector on a first surface of a substrate. The first connector is surrounded by a plurality of conductive vias that are electrically coupled together to form a toroidal inductor integral with the substrate. The first connector is electrically coupled to the toroidal inductor. The instructions also cause the processor to initiate formation of a second connector on a second surface of the substrate. The second connector is surrounded by the plurality of conductive vias. The second connector is electrically coupled to the toroidal inductor.

In a particular embodiment, a method includes a step for forming a first connector on a first surface of a substrate. The first connector is surrounded by a plurality of conductive vias that are electrically coupled together to form a toroidal inductor integral with the substrate. The first connector is electrically coupled to the toroidal inductor. The method also includes a step for forming a second connector on a second surface of the substrate. The second connector is electrically coupled to the toroidal inductor.

One particular advantage provided by at least one of the disclosed embodiments is that a device with a toroidal inductor integrated with a substrate with connectors of the toroidal inductor surrounded by conductive vias of the toroidal inductor is that the device may have a smaller footprint as compared to a similar device with a toroidal inductor integrated with a substrate with connectors of the toroidal inductor offset outwards from the conductive vias of the toroidal inductor. Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a top view of a particular illustrative embodiment of a device with a substrate integrated with toroidal inductors, where connectors for the toroidal inductors are located within central regions of the toroidal inductors;

FIG. 2 is a cross-sectional representation taken substantially along line 2-2 of FIG. 1 of a portion of a device with connectors of a toroidal inductor surrounded by conductive vias of the toroidal inductor;

FIG. 3 is a cross-sectional representation of a particular illustrative embodiment of a portion of a device having an integrated toroidal inductor, where connectors of the toroidal inductor are surrounded by conductive vias of the toroidal inductor and where a connector includes a capacitor;

FIG. 4. depicts simulation results of inductance versus frequency and simulation results of quality factor (Q) versus frequency for a first device with a toroidal inductor integrated with a substrate with connectors for the toroidal inductor located outside of a central region of the toroidal inductor and a second device with a toroidal inductor integrated with a substrate with connectors for the toroidal inductor located inside of a central region of the toroidal inductor;

FIG. 5 is a flow chart of a particular illustrative embodiment of a method of forming a device with connectors of a toroidal inductor integrated with a substrate so that the connectors are surrounded by conductive vias of the toroidal inductor;

FIG. 6 is a block diagram of portable device including connectors for a toroidal inductor integrated with a substrate surrounded by conductive vias of the toroidal inductor; and

FIG. 7 is a data flow diagram of a particular illustrative embodiment of a manufacturing process to manufacture electronic devices that include toroidal inductors integrated with substrates surrounded by conductive vias of the toroidal inductors.

### V. DETAILED DESCRIPTION

Particular embodiments of devices that include a toroidal inductor integrated with a substrate, where connectors of the toroidal inductor that enable the toroidal inductor to be coupled to devices external to the device are surrounded by conductive vias of the toroidal inductor, are presented in this disclosure. It should be appreciated, however, that the concepts and insights used in the particular embodiments with respect to the designs of the devices may be embodied in a variety of contexts. The particular embodiments presented are merely illustrative, and do not limit the scope of this disclosure.

The present disclosure describes the particular embodiments in specific contexts. However, features, methods, structures or characteristics described according to the particular embodiments may also be combined in suitable manners to form one or more other embodiments. In addition, figures are used to illustrate the relative relationships between the features, methods, structures, or characteristics, and thus may not be drawn in scale. Directional terminology, such as “top,” “bottom,” “front,” “back,” etc. is used with reference to the orientation of the figures being described. As such, the directional terminology is used for purposes of illustration and is not meant to be limiting.

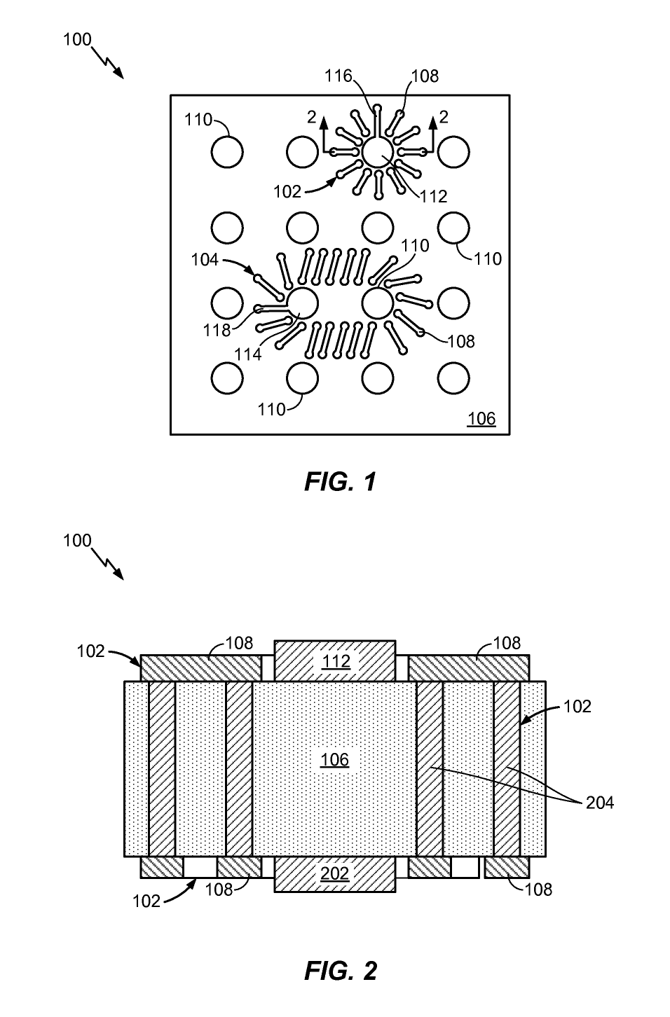

Referring to FIG. 1, a particular illustrative embodiment of a device with toroidal inductors 102, 104 integrated in a substrate 106 is disclosed and generally designated 100. FIG. 1 depicts a top view of a particular illustrative embodiment of the device 100. The device 100 may be an interposer device that facilitates connecting two or more devices together. The two or more devices may be, but are not limited to, circuit boards, integrated circuits, transistors, diodes, resistors, capacitors, inductors, other electrical devices, or combinations thereof.

The toroidal inductors 102, 104 may be formed by a plurality of conductive vias that extend from a first side of the substrate 106 to a second side of the substrate 106 (e.g., the conductive vias 204 depicted in FIG. 2). The conductive vias may be electrically coupled together by a plurality of leads 108. In other embodiments, the device 100 may include only a single toroidal inductor, two toroidal inductors located in other locations, or more than two toroidal inductors.

The substrate 106 may be made of a low-loss material (e.g., a dielectric, a wide-bandgap semiconductor, etc.). The low-loss material may include a dielectric material or a highly-insulative semiconductor material. The substrate 106 may include a glass substrate, a quartz substrate, a silicon-on-insulator (SOI) substrate, a silicon-on-sapphire (SOS) substrate, a high resistivity substrate (HRS), a gallium arsenide (GaAs) substrate, an indium phosphide (InP) substrate, a silicon carbide (SiC) substrate, an aluminum nitride (AlN) substrate, a rogers laminate substrate, a polymeric substrate, or combinations thereof, as illustrative, non-limiting examples.

The device 100 may include a plurality of connectors 110, 112, 114. The connectors 110, 112, 114 may be ball/bump pads or other types of connectors that enable the device 100 to be coupled to one or more devices external to the device 100. The connectors 110, which are not electrically coupled to the toroidal inductors 102, 104, may be electrically coupled by conductive vias that extend through the substrate 106 to corresponding connectors on an opposite side of the substrate 106. The connector 112 may be electrically coupled to the first toroidal inductor 102. The connector 114 may be electrically coupled to the second toroidal inductor 104. In other embodiments, the device 100 may include fewer or more connectors that are located in regular patterns or non-regular patterns on the device 100.

The connector 112 may be electrically coupled to the first toroidal inductor 102 by a lead 116. A second connector on the opposite side of the substrate 106 may be electrically coupled to the first toroidal inductor 102 by another lead. The connector 112 and the second connector may be surrounded by conductive vias through the substrate 106 that are electrically coupled together by the leads 108 to form the toroidal inductor 102. The connector 114 may be electrically coupled to the second toroidal inductor 104 by a lead 118. A third connector on an opposite side of the substrate 106 may be electrically coupled to the second toroidal inductor 104 by another lead. The connector 114 and the third connector may be surrounded by conductive vias through the substrate 106 that are electrically coupled together by leads 108 to form the toroidal inductor 104. The leads 108, 116, 118 and the connectors 110, 112, 114 may include, but are not limited to, solder, copper (Cu), tungsten (W), silver (Ag), gold (Au), or combinations or alloys thereof

FIG. 1 depicts the device 100 with the connectors 112, 114 of the toroidal inductors 102, 104 positioned in central regions of the toroidal inductors 102, 104. The connectors 112, 114, and connectors for the toroidal inductors 102, 104 on the second side of the substrate may be surrounded by conductive vias of the toroidal inductors 102, 104 that are electrically coupled together by the leads 108.

The device 100 may include one or more elongated toroidal inductors. For example, the toroidal inductor 104 is an elongated toroidal inductor with conductive vias surrounding the connector 114. The connector 114 is coupled to a first end conductive via by the lead 118. A corresponding connector is coupled to a second end conductive via by a lead on a second side of the substrate 106. The connector 110 is located in a central region of the toroidal inductor 104 (e.g., between the leads 108 that electrically couple conductive vias of the toroidal inductor 104 together). A connector on the second side of the substrate 106 may be coupled to the connector 110 by a conductive via. Surrounding the connectors 112, 114 of the toroidal inductors 102, 104 with the conductive vias of the toroidal inductors 102, 104 may utilize space associated with the central regions of the toroidal inductors 102, 104 and may result in the device 100 having a smaller footprint than a device that has connectors external to the central regions of the toroidal inductors.

FIG. 2 is a cross-sectional representation taken substantially along line 2-2 of FIG. 1. FIG. 2 depicts a portion of the device 100 with connectors 112, 202 of the toroidal inductor 102 surrounded by conductive vias 204 of the toroidal inductor 102. The connector 112 may be electrically coupled to a first end conductive via of the conductive vias 204 by a lead (e.g., by the lead 116 depicted in FIG. 1), and the connector 202 may be coupled to a second end conductive via of the conductive vias 204 by another lead. The end conductive vias may be a first particular conductive via that begins a toroid of the toroidal inductor 102 and a second particular conductive via that ends the toroid of toroidal inductor 102.

The device 100 may include the substrate 106. The device 100 may include the conductive vias 204, which extend from a first side of the substrate 106 to a second side of the substrate 106. The conductive vias 204 may be electrically coupled together by leads 108. The conductive vias 204 may be metal filled, may include plated sides with empty cores, or may include plated sides with polymer filled cores. The metal of the conductive vias 204 may be, but is not limited to, copper (Cu), tungsten (W), silver (Ag), gold (Au), or combinations or alloys thereof. The polymer cores may include, but are not limited to, polyimides (PI), benzocyclobutenes (BCB), acrylics, polybenzoxazoles (PBO), photoresists (e.g., TMMR®, SU-8, or other types of photoresists), or combinations thereof. Having polymer cores or empty cores may enable the conductive vias 204 to provide structural support for the device 100 and may be more compatible with TGV fabrication techniques than completely filling the conductive vias 204 with metal. In addition, having empty cores or polymer cores may reduce material costs of the conductive vias 104 (e.g., polymer materials may cost less than metal).

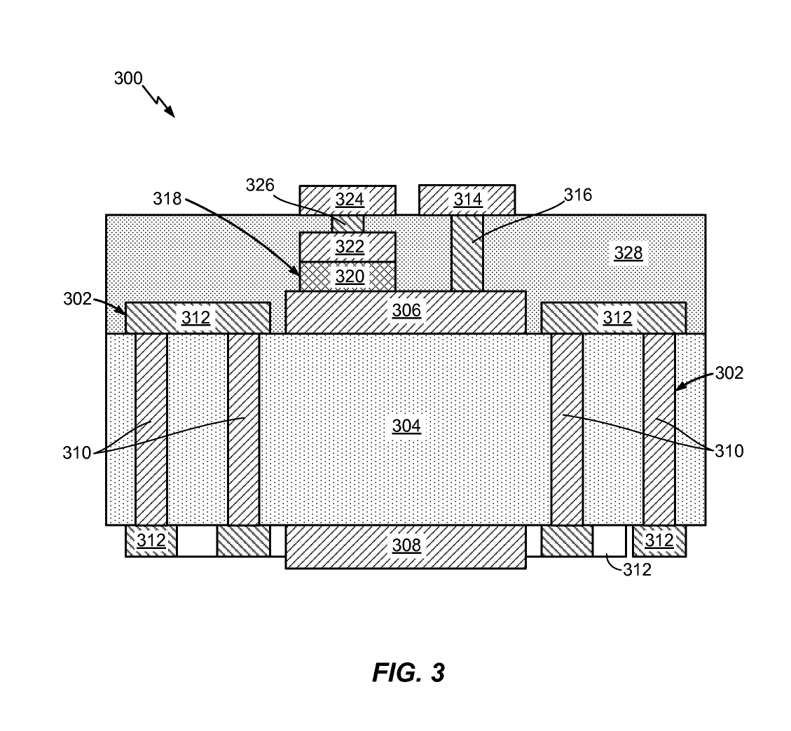

Referring to FIG. 3, a particular illustrative embodiment of a circuit including a capacitor with a dielectric between a via and a plate of the capacitor is disclosed. FIG. 3 depicts a cross-sectional representation of a particular illustrative embodiment of a portion of a device 300 having a toroidal inductor 302 integrated with a substrate 304, where connectors 306, 308 of the toroidal inductor 302 are surrounded by conductive vias 310 of the toroidal inductor 302. The conductive vias 306, 308 may be electrically coupled to end conductive vias of the conductive vias 310 by leads. The end conductive vias may be a first particular conductive via that begins a toroid of the toroidal inductor 302 and a second particular conductive via that ends the toroid of toroidal inductor 302.

The device 300 may include the toroidal inductor 302. The toroidal inductor 302 may include the conductive vias 310 that extend through the substrate 304 from a first side of the substrate 304 to a second side of the substrate 304. The conductive vias 310 may be electrically coupled together to form the toroidal inductor 302 by leads 312. The conductive vias 310 may surround the connectors 306, 308. The toroidal inductor 302 may be electrically coupled to a device external to the device 300 by a connector 314 that is electrically coupled to the connector 306 by a conductive via 316.

The device 300 also includes a capacitor 318 coupled to the connector 306. The capacitor 318 may include a dielectric 320 between a first plate 322 and the connector 306, which may act as a second plate of the capacitor 318. The dielectric 320 may include, but is limited to, silicon dioxide (SiO₂), silicon nitride (Si₃N₄), silicon oxynitride (SiOₓN_{y}), tantalum pentoxide (Ta₂O₅), aluminum oxide (Al₂O₃), aluminum nitride (AlN), or combinations thereof. The first plate 322 may enable the capacitor 318 to be electrically coupled to a device external to the device 300 by a connector 324 that is electrically coupled to the first plate 322 by a connective via 326. The capacitor 318 may be located in an inter-layer dielectric 328 to insulate the capacitor 318 from other devices or circuitry.

The toroidal inductor 302 and the capacitor 318 may form a resonant circuit. For example, when the capacitor 318 is charged with a first polarity and begins to discharge, an electric current may begin flowing through the toroidal inductor 302. While the capacitor 318 discharges, a magnetic field of the toroidal inductor 302 may build as a result of the electric current flowing through the toroidal inductor 302. After the capacitor 318 has discharged, the magnetic field may cause the capacitor 114 to charge with an opposite polarity to the first polarity as flow of the electric current through the toroidal inductor 302 reduces. A second electric current in an opposite direction of the electric current may then begin flowing through the toroidal inductor 302 as a strength of the magnetic field is reduced. The second electric current may discharge the capacitor 318 and then recharge the capacitor 318 with the first polarity. Voltage across the capacitor 318 and the toroidal inductor 302 may oscillate at a frequency (e.g., a resonant frequency) approximately equal to a capacitance value of the capacitor 318 multiplied by an inductance value of the toroidal inductor 302. Losses in current due to resistance may dampen oscillations and may reduce efficiency of the circuit. Coupling the capacitor 318 to the connector 306 may result in small resistance losses for the resonant circuit as compared to connectors that are located external to the conductive vias 310 of the toroidal inductor 302.

The device 300 may be a radio frequency (RF) device (e.g., a diplexer) for use in wireless communication devices. The device 300 may be formed using through-glass-via (TGV) technology to provide smaller size, higher performance, simplified manufacturing, and cost advantages as compared to a similar device formed by multi-layer chip diplexer (MLCD) technology. The capacitor 318 may be a metal-insulator-metal capacitor or other type of capacitor. The capacitor 318 may be coupled in series, or in parallel, with the inductor 302 to achieve designed circuit functions.

FIG. 3 illustrates the capacitor 318 and the connector 314 coupled to the connector 306. In other embodiments, the device 300 may include a capacitor coupled to the connector 308, a capacitor and a connector coupled to the connector 308, the capacitor 318 coupled to the connector 306 without the connector 314 and the conductive via 316, or combinations thereof. The capacitor coupled to the connector 308 may be coupled in series, or in parallel, with the inductor 302.

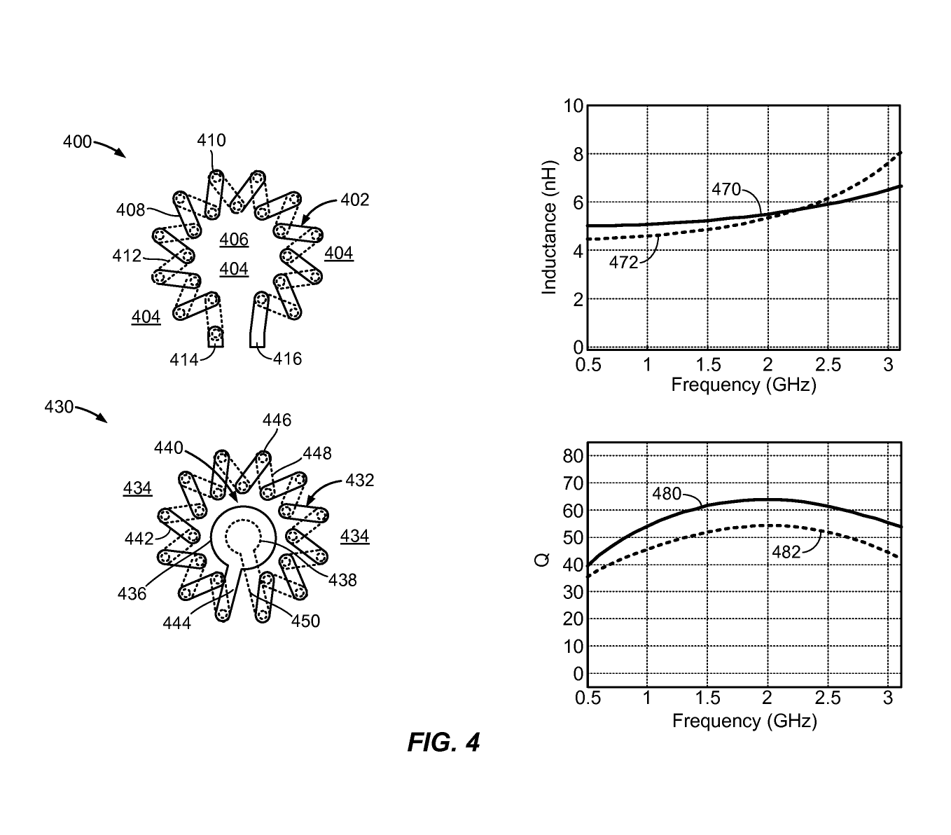

FIG. 4. depicts simulation results of inductance versus frequency and simulation results of quality factor (Q) versus frequency for a first device 400 and a second device 430. The first device includes a toroidal inductor 402 integrated with a substrate 404 with connectors for the toroidal inductor 402 located outside of a central region 406 of the toroidal inductor 402. The second device 430 includes a toroidal inductor 432 integrated with a substrate 434 with connectors 436, 438 for the toroidal inductor 432 located inside of a central region 440 of the toroidal inductor 432. For the top view representation of the first device 400 depicted in FIG. 4, solid lines indicate leads 408 on a top surface of the substrate 404, dashed circles indicate conductive vias 410 beneath the leads 408, and dashed lines indicate leads 412 on a bottom surface of the substrate 404. Connectors for the toroidal inductor 402 are located outside of the central region 406 defined by the toroidal inductor 402. The connectors for the toroidal inductor 402 are coupled to leads 414, 416.

For the top view representation of the second device 430 depicted in FIG. 4, solid lines indicate leads 442, 444 and the first connector 436 on a top surface of the substrate 434, dashed circles indicate conductive vias 446 beneath the leads 442, and dashed lines indicate leads 448, 450 and the second connector 438 on a bottom surface of the substrate 434. Connectors 436, 438 are surrounded by the conductive vias 446 that form the toroidal inductor 432.

Curve 470 depicts simulation results of inductance versus frequency for the first device 400, and curve 472 depicts simulation results of inductance versus frequency for the second device 430. Curve 480 depicts simulation results of quality factor versus frequency for the first device 400, and curve 482 depicts simulation results of quality factor versus frequency for the second device 430. Table 1 depicts values from the simulation results at a frequency of 1 GHz. The curves 470, 472, 480, 482 and the values from Table 1 show that a device formed with a toroidal inductor integrated in a substrate such that connectors for the toroidal inductor are surrounded by conductive vias of the toroidal inductor (e.g., the second device 430 of FIG. 4) has comparable performance to a similar device with a toroidal inductor integrated in a substrate where the connectors of the toroidal inductor are not surrounded by conductive vias of the toroidal inductor (e.g., the first device 400 of FIG. 4).

TABLE 1

| | Device 400 | Device 430 |
|---|---|---|
| L (nH) | 5.1 | 4.6 |
| Q | 54 | 46 |

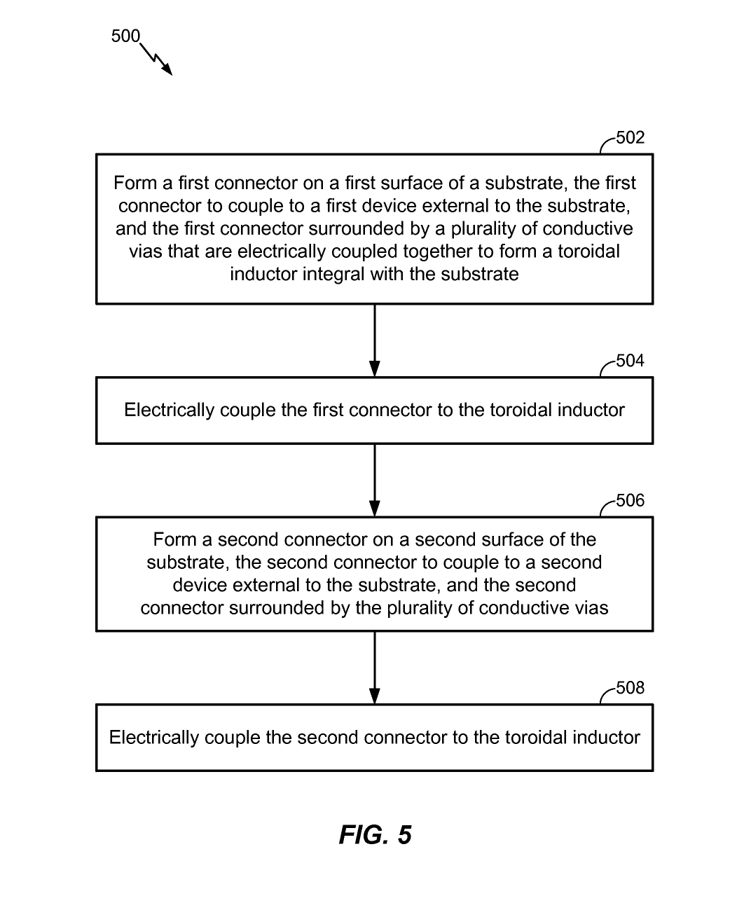

Referring to FIG. 5, a flow chart of a particular illustrative embodiment of a method of forming a device with connectors of a toroidal inductor integrated with a substrate so that the connectors are surrounded by conductive vias of the toroidal inductor is depicted and generally designated 500. The device may be any of the devices 100, 300, 430 of FIGS. 1-4.

The method 500 includes forming a first connector on a first surface of a substrate, at 502. The first connector may be configured to electrically couple to a first device external to the device (e.g., a circuit board or a RF chip of a RF chip set). The first connector may be surrounded by a plurality of conductive vias that are electrically coupled together to form a toroidal inductor integral with the substrate. In a first particular embodiment, the first connector may be formed using one or more deposition processes, such as, but not limited to, electroplating, physical vapor deposition (PVD) (e.g., sputtering or evaporation), chemical vapor deposition (CVD), or combinations thereof. In a second particular embodiment, the first connector may be formed by mechanical removal, chemical removal, or both, of a metal layer deposited on the substrate. A planarization process may be used to remove unwanted or excess materials and to create a flat surface for subsequent processing. The planarization process may include, but is not limited to chemical-mechanical polish (CMP), an etch-back planarization process, or combinations thereof. In a particular embodiment, a solder ball or other electrically conductive material maybe coupled to the first connector to facilitate electrically coupling the first connector to the first device.

The method 500 includes electrically coupling the first connector to the toroidal inductor, at 504. Electrically coupling the first connector to the toroidal inductor may include forming a lead between the first connector and a first end conductive via of the conductive vias that form the toroidal inductor. The lead may be formed using one or more deposition processes or by one or more removal processes. In a particular embodiment, electrically coupling the first connector to the toroidal inductor, at 504, happens when the first connector is formed on the first surface of the substrate, at 502 (e.g., the first connector is formed coupled to the toroidal inductor).

The method 500 includes forming a second connector on a second surface of a substrate, at 506. The second connector may be configured to electrically couple to a second device external to the device (e.g., a circuit board or a RF chip of a RF chip set). The second connector may be surrounded by the plurality of conductive vias. The second connector may be formed by one or more deposition processes; by mechanical removal, chemical removal, or both, of a metal layer deposited on the substrate; or by combinations thereof. A planarization process may be used to remove unwanted or excess materials and to create a flat surface for subsequent processing. In a particular embodiment, a solder ball or other electrically conductive material may be coupled to the second connector to facilitate electrically coupling the second connector to the second device.

The method 500 includes electrically coupling the second connector to the toroidal inductor, at 508. Electrically coupling the second connector to the toroidal inductor may include forming a lead between the second connector and a second end conductive via of the conductive vias that form the toroidal inductor. The lead may be formed using one or more deposition processes or by one or more removal processes. In a particular embodiment, electrically coupling the second connector to the toroidal inductor, at 508, happens when the second connector is formed on the second surface of the substrate, at 506 (e.g., the second connector is formed coupled to the toroidal inductor).

In some embodiments, the method may also include forming a dielectric layer on a portion of the first connector or on a portion of the second connector. A metal layer may be formed on top of the dielectric layer to form a capacitor.

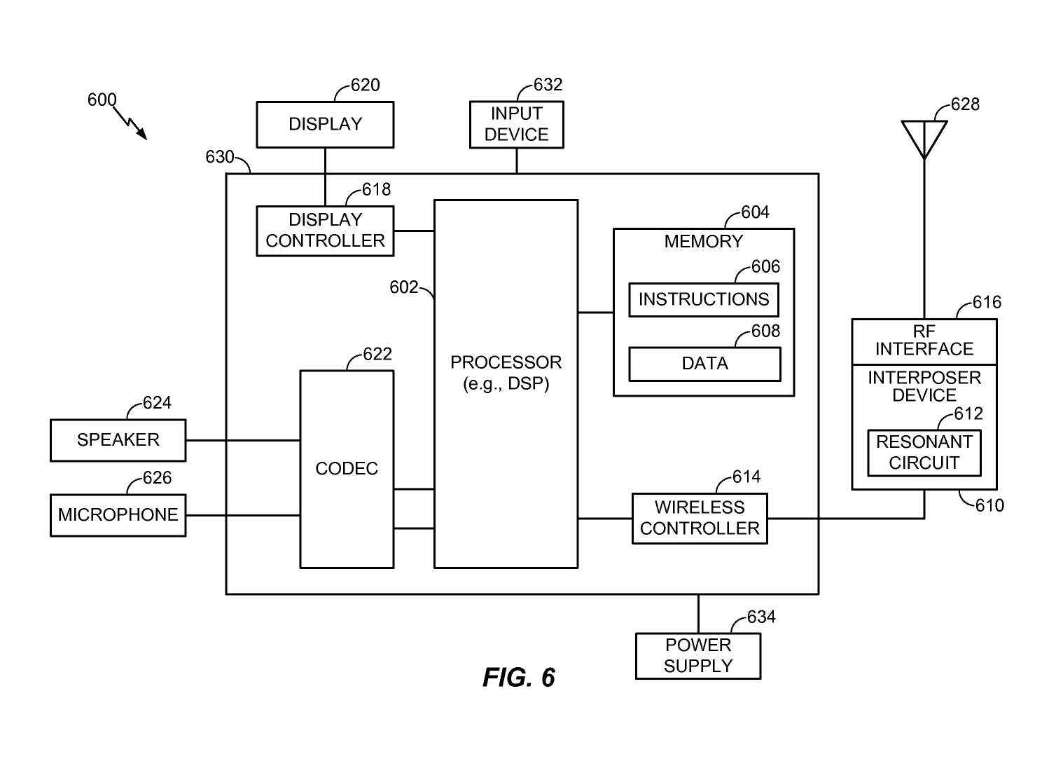

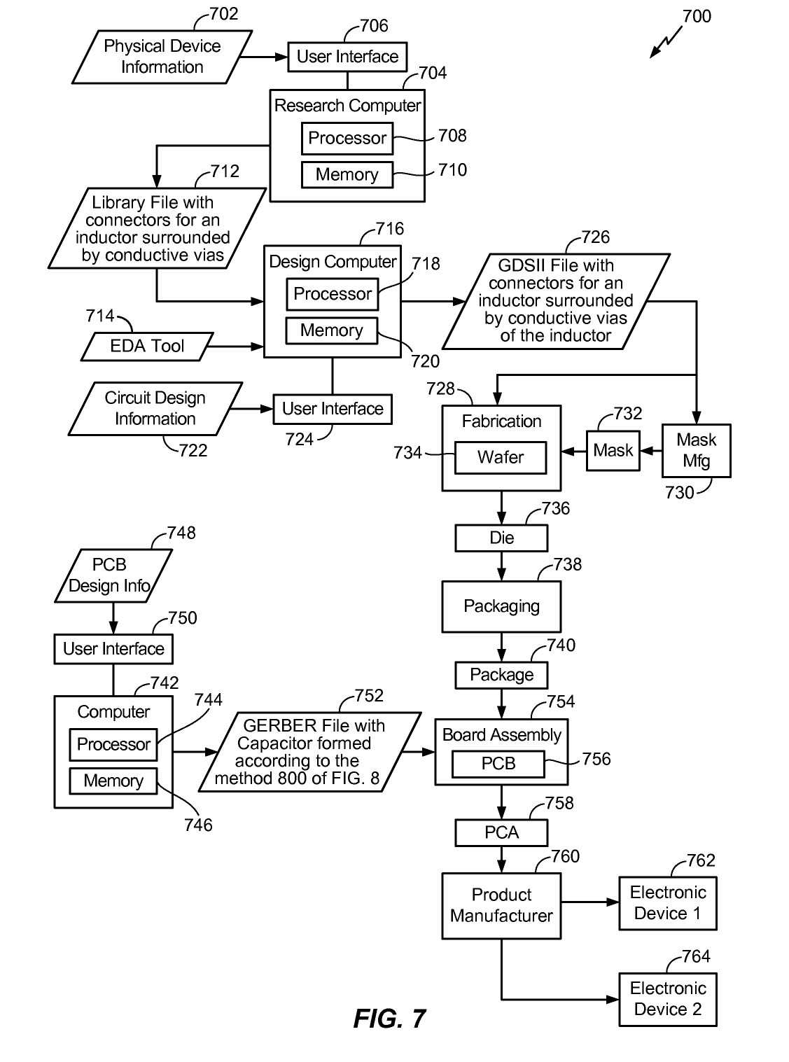

The method of FIG. 5 may be initiated or controlled by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 500 of FIG. 5 may be performed by fabrication equipment including a processor that executes instructions stored at a memory (e.g., a non-transitory computer-readable medium), as described further with reference to FIG. 6. As another example, the method 500 of FIG. 5 may be performed by fabrication equipment including a processor that executes instructions stored at a memory (e.g., a non-transitory computer-readable medium), as described further with reference to FIG. 7.

Referring to FIG. 6, a block diagram of a particular illustrative embodiment of a wireless communication device is depicted and generally designated 600. The device 600 includes a processor 602 (e.g., a digital signal processor (DSP)) coupled to a memory 604 (e.g., a random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art). The memory 604 may store instructions 606 executable by the processor 602. The memory 604 may store data 608 accessible to the processor 602.

The device 600 includes an interposer device 610 positioned between portions of the device 600. The interposer device 610 may include a toroidal inductor integrated with a substrate. Connectors for the interposer device 610 may be located on surfaces of the substrate surrounded by a toroid of the toroidal inductor. The interposer device 610 may also include a capacitor. The capacitor and the toroidal inductor may form a resonant circuit 612. In an illustrative embodiment, the interposer device 610 may correspond to one or more of the devices 100, 300, 430 of FIGS. 1-4, a device formed according to the method 500 of FIG. 5, or a combination thereof. For example, as depicted in FIG. 6, the interposer device 610 may be positioned between a wireless controller 614 and a RF interface 616. The interposer device 610 may include the resonant circuit 612.

FIG. 6 also shows a display controller 618 that is coupled to the digital signal processor 602 and to a display 620. A coder/decoder (CODEC) 622 can also be coupled to the digital signal processor 602. A speaker 624 and a microphone 626 can be coupled to the CODEC 622. FIG. 6 also indicates that the wireless controller 614 can be coupled to the digital signal processor 602 and to a wireless antenna 628 via the interposer device 610 and the RF interface 616.

In a particular embodiment, the DSP 602, the memory 604, the wireless controller 614, the display controller 618, and the CODEC 622 are included in a system-in-package or system-on-chip device 630. In a particular embodiment, an input device 632 and a power supply 634 are coupled to the system-on-chip device 630. Moreover, in a particular embodiment, as illustrated in FIG. 6, the display 620, the input device 632, the speaker 624, the microphone 626, the wireless antenna 628, and the power supply 634 are external to the system-on-chip device 630. However, each of the display 620, the input device 632, the speaker 624, the microphone 626, the wireless antenna 628, and the power supply 634 can be coupled to a component of the system-on-chip device 630, such as an interface or a controller.

The foregoing disclosed devices and functionalities may be designed and configured as computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. The chips are then employed in devices described above. FIG. 7 depicts a particular illustrative embodiment of an electronic device manufacturing process 700.

Referring to FIG. 7, a particular illustrative embodiment of an electronic device manufacturing process is depicted and generally designated 700. In FIG. 7, physical device information 702 is received at the manufacturing process 700, such as at a research computer 704. The physical device information 702 may include design information representing at least one physical property of an electronic device, such as a toroidal inductor integrated in a substrate including connectors surrounded by conductive vias that form the toroidal inductor (e.g., the devices 100, 300, 430 of FIGS. 1-4, a device formed according to the method 500 of FIG. 5, or a combination thereof). For example, the physical device information 702 may include physical parameters, material characteristics, and structure information that is entered via a user interface 706 coupled to the research computer 704. The research computer 704 includes a processor 708, such as one or more processing cores, coupled to a computer readable medium such as a memory 710. The memory 710 may store computer readable instructions that are executable to cause the processor 708 to transform the physical device information 702 to comply with a file format and to generate a library file 712.

In a particular embodiment, the library file 712 includes at least one data file including the transformed design information. For example, the library file 712 may include a library of interposer device (e.g., the devices 100, 300, 430 of FIGS. 1-4, a device formed according to the method 500 of FIG. 5, or a combination thereof) provided for use with an electronic design automation (EDA) tool 714.

The library file 712 may be used in conjunction with the EDA tool 714 at a design computer 716 including a processor 718, such as one or more processing cores, coupled to a memory 720. The EDA tool 714 may be stored as processor executable instructions at the memory 720 to enable a user of the design computer 716 to design a circuit including the interposer device (e.g., the devices 100, 300, 430 of FIGS. 1-4, a device formed according to the method 500 of FIG. 5, or a combination thereof) of the library file 712. For example, a user of the design computer 716 may enter circuit design information 722 via a user interface 724 coupled to the design computer 716. The circuit design information 722 may include design information representing at least one physical property of a semiconductor device, such as the interposer device (e.g., the devices 100, 300, 430 of FIGS. 1-4, a device formed according to the method 500 of FIG. 5, or a combination thereof). To illustrate, the circuit design property may include identification of particular circuits and relationships to other elements in a circuit design, positioning information, feature size information, interconnection information, or other information representing a physical property of a semiconductor device.

The design computer 716 may be configured to transform the design information, including the circuit design information 722, to comply with a file format. To illustrate, the file formation may include a database binary file format representing planar geometric shapes, text labels, and other information about a circuit layout in a hierarchical format, such as a Graphic Data System (GDSII) file format. The design computer 716 may be configured to generate a data file including the transformed design information, such as a GDSII file 726 that includes information describing the interposer device (e.g., the devices 100, 300, 430 of FIGS. 1-4, a device formed according to the method 500 of FIG. 5, or a combination thereof), in addition to other circuits or information.

The GDSII file 726 may be received at a fabrication process 728 to manufacture the interposer device (e.g., the devices 100, 300, 430 of FIGS. 1-4, a device formed according to the method 500 of FIG. 5, or a combination thereof), according to transformed information in the GDSII file 726. For example, a device manufacture process may include providing the GDSII file 726 to a mask manufacturer 730 to create one or more masks, such as masks to be used with photolithography processing, illustrated as a representative mask 732. The mask 732 may be used during the fabrication process to generate one or more wafers 734, which may be tested and separated into dies, such as a representative die 736. The die 736 includes a circuit including the interposer device (e.g., the devices 100, 300, 430 of FIGS. 1-4, a device formed according to the method 500 of FIG. 5, or a combination thereof).

The die 736 may be provided to a packaging process 738 where the die 736 is incorporated into a representative package 740. For example, the package 740 may include the single die 736 or multiple dies, such as a system-in-package (SiP) arrangement. The package 740 may be configured to conform to one or more standards or specifications, such as Joint Electron Device Engineering Council (JEDEC) standards.

Information regarding the package 740 may be distributed to various product designers, such as via a component library stored at a computer 742. The computer 742 may include a processor 744, such as one or more processing cores, coupled to a memory 746. A printed circuit board (PCB) tool may be stored as processor executable instructions at the memory 746 to process PCB design information 748 received from a user of the computer 742 via a user interface 750. The PCB design information 748 may include physical positioning information of a packaged semiconductor device on a circuit board, the packaged semiconductor device corresponding to the package 740 including the interposer device (e.g., the devices 100, 300, 430 of FIGS. 1-4, a device formed according to the method 500 of FIG. 5, or a combination thereof).

The computer 742 may be configured to transform the PCB design information 748 to generate a data file, such as a GERBER file 752 with data that includes physical positioning information of a packaged semiconductor device on a circuit board, as well as layout of electrical connections such as traces and vias, where the packaged semiconductor device corresponds to the package 740 including the interposer device (e.g., the devices 100, 300, 430 of FIGS. 1-4, a device formed according to the method 500 of FIG. 5, or a combination thereof). In other embodiments, the data file generated by the transformed PCB design information may have a format other than a GERBER format.

The GERBER file 752 may be received at a board assembly process 754 and used to create PCBs, such as a representative PCB 756, manufactured in accordance with the design information stored within the GERBER file 752. For example, the GERBER file 752 may be uploaded to one or more machines to perform various steps of a PCB production process. The PCB 756 may be populated with electronic components including the package 740 to form a representative printed circuit assembly (PCA) 758.

The PCA 758 may be received at a product manufacture process 760 and integrated into one or more electronic devices, such as a first representative electronic device 762 and a second representative electronic device 764. As an illustrative, non-limiting example, the first representative electronic device 762, the second representative electronic device 764, or both, may be selected from the group of a set top box, a music player, a video player, an entertainment unit, a navigation device, a communications device, a personal digital assistant (PDA), a fixed location data unit, and a computer, into which the interposer device (e.g., the devices 100, 300, 430 of FIGS. 1-4, a device formed according to the method 500 of FIG. 5, or a combination thereof) is integrated. As another illustrative, non-limiting example, one or more of the electronic devices 762 and 764 may be remote units such as mobile phones, hand-held personal communication systems (PCS) units, portable data units such as personal data assistants, global positioning system (GPS) enabled devices, navigation devices, fixed location data units such as meter reading equipment, or any other device that stores or retrieves data or computer instructions, or any combination thereof. Although FIG. 7 illustrates remote units according to teachings of the disclosure, the disclosure is not limited to these illustrated units. Embodiments of the disclosure may be suitably employed in any device which includes active integrated circuitry including memory and on-chip circuitry.

A device that includes the interposer device (e.g., the devices 100, 300, 430 of FIGS. 1-4, a device formed according to the method 500 of FIG. 5, or a combination thereof), may be fabricated, processed, and incorporated into an electronic device, as described in the illustrative process 700. One or more aspects of the embodiments disclosed with respect to FIGS. 1-3, 5, and 7 may be included at various processing stages, such as within the library file 712, the GDSII file 726, and the GERBER file 752, as well as stored at the memory 710 of the research computer 704, the memory 720 of the design computer 716, the memory 746 of the computer 742, the memory of one or more other computers or processors (not shown) used at the various stages, such as at the board assembly process 754, and also incorporated into one or more other physical embodiments such as the mask 732, the die 736, the package 740, the PCA 758, other products such as prototype circuits or devices (not shown), or any combination thereof. Although various representative stages of production from a physical device design to a final product are depicted, in other embodiments fewer stages may be used or additional stages may be included. Similarly, the process 700 may be performed by a single entity or by one or more entities performing various stages of the process 700.

In conjunction with the described embodiments, an apparatus is disclosed that includes means for supporting layers integrated with a means for storing energy in a magnetic field. The means for supporting layers may include the substrates of FIGS. 1-3 and 5. The means for storing energy in a magnetic field may include the toroidal inductors depicted in FIGS. 1-3, and 5.

The apparatus also includes means for making first electrical contact on the means for supporting layers and means for making second electrical contact on the means for supporting layers. The means for making first electrical contact and the means for making second electrical contact may include the connectors 112, 114, 202, 306, 308, 324, 314, 436, and 438 depicted in FIGS. 1-4.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A device comprising:
a substrate;
a first connector coupled to a first surface of the substrate, the first connector configured to be electrically coupled to a first device external to the substrate;
a second connector coupled to a second surface of the substrate; and
a plurality of conductive vias extending through the substrate from the first surface to the second surface and surrounding the first connector and the second connector, wherein the plurality of conductive vias are electrically coupled together to form a toroidal inductor, wherein a first lead of the toroidal inductor is electrically coupled to the first connector, and wherein a second lead of the toroidal inductor is electrically coupled to the second connector.

2. The device of claim 1, further comprising a capacitor coupled to the first connector.

3. The device of claim 2, further comprising an inter-layer dielectric, wherein the capacitor is located in the inter-layer dielectric.

4. The device of claim 2, wherein the capacitor is a metal-insulator-metal (MIM) capacitor.

5. The device of claim 2, wherein the capacitor is coupled in series with the toroidal inductor.

6. The device of claim 2, wherein the capacitor is coupled in parallel with the toroidal inductor.

7. The device of claim 1, wherein the substrate comprises a glass substrate, a quartz substrate, a silicon-on-insulator (SOI) substrate, a silicon-on-sapphire (SOS) substrate, a high resistivity substrate (HRS), a gallium arsenide (GaAs) substrate, an indium phosphide (InP) substrate, a silicon carbide (SiC) substrate, an aluminum nitride (AlN) substrate, a rogers laminate substrate, a polymeric substrate, or combinations thereof.

8. The device of claim 1, wherein the first connector comprises a bump pad.

9. The device of claim 1, wherein the first connector comprises a ball pad.

10. The device of claim 1, wherein the first device comprises an integrated circuit of a radio frequency chipset.

11. The device of claim 1, wherein the first device comprises a circuit board.

12. The device of claim 1, wherein the second connector is configured to be coupled to a second device external to the substrate.

13. A method comprising:
forming a first connector on a first surface of a substrate, the first connector configured to be electrically coupled to a first device external to the substrate, and the first connector surrounded by a plurality of conductive vias that are electrically coupled together to form a toroidal inductor integral with the substrate;
electrically coupling the first connector to the toroidal inductor;
forming a second connector on a second surface of the substrate, the second connector configured to be electrically coupled to a second device external to the substrate, and the second connector surrounded by the plurality of conductive vias; and
electrically coupling the second connector to the toroidal inductor.

14. The method of claim 13, further comprising:
forming a dielectric layer on a portion of the first connector; and
forming a metal layer over the dielectric layer.

15. The method of claim 14, wherein the dielectric comprises silicon dioxide (SiO₂), silicon nitride (Si₃N₄), silicon oxynitride (SiOₓN_{y}), tantalum pentoxide (Ta₂O₅), aluminum oxide (Al₂O₃), aluminum nitride (AlN), or combinations thereof.

16. The method of claim 13, wherein the first connector comprises copper (Cu), tungsten (W), silver (Ag), gold (Au) or combinations or alloys thereof.

17. An apparatus comprising:
means for supporting layers integrated with a means for storing energy in a magnetic field;
means for making first electrical contact on the means for supporting layers, wherein the means for making first electrical contact is surrounded by conductive vias of the means for storing energy in the magnetic field; and
means for making second electrical contact on the means for supporting layers, wherein the means for making the second electrical contact is surrounded by the conductive vias of the means for storing energy in the magnetic field.

18. The apparatus of claim 17, integrated in at least one die.

19. The apparatus of claim 17, further comprising a device selected from a mobile phone, a communications device, a tablet, a navigation device, a personal digital assistant (PDA), a set top box, a music player, a video player, an entertainment unit, a fixed location data unit, and a computer, into which the means for supporting layers integrated with the means for storing energy in a magnetic field, the means for making first electrical contact on the means for supporting layers and the means for making second electrical contact on the means for supporting layers are integrated.

20. A computer-readable storage device storing instructions that, when executed by a processor cause the processor to:
initiate formation of a first connector on a first surface of a substrate, the first connector surrounded by a plurality of conductive vias that are electrically coupled together to form a toroidal inductor integral with the substrate, wherein the first connector is electrically coupled to the toroidal inductor; and
initiate formation of a second connector on a second surface of the substrate, the second connector surrounded by the plurality of conductive vias, wherein the second connector is electrically coupled to the toroidal inductor.

21. The computer-readable storage device of claim 20, wherein the processor is integrated into an electronic device.

22. A method comprising:
a step for forming a first connector on a first surface of a substrate, the first connector surrounded by a plurality of conductive vias that are electrically coupled together to form a toroidal inductor integral with the substrate, wherein the first connector is electrically coupled to the toroidal inductor; and
a step for forming a second connector on a second surface of the substrate, the second connector surrounded by the plurality of conductive vias, wherein the second connector is electrically coupled to the toroidal inductor.

23. The method of claim 22, wherein the step for forming the first connector and the step for forming the second connector are initiated by a processor integrated into an electronic device.

24. A method comprising:
receiving a data file including design information corresponding to an interposer device of a chipset;
fabricating the interposer device according to the design information, wherein the interposer device includes:
a substrate;
a first connector on a first surface of the substrate, the first connector configured to be coupled to a first device external to the substrate;
a second connector on a second surface of the substrate; and
a plurality of conductive vias extending through the substrate from the first surface to the second surface and surrounding the first connector and the second connector, wherein the plurality of conductive vias are electrically coupled together to form a toroidal inductor, wherein a first lead of the toroidal inductor is electrically coupled to the first connector, and wherein a second lead of the toroidal inductor is electrically coupled to the second connector.

25. The method of claim 24, wherein the data file has a Graphic Data System (GDSII) format.

26. The method of claim 24, wherein the data file has a GERBER format.
